(19) United States
(12) Patent Application Publication
(10) Pub. No.: US 2005/0001904 A1
(43) Pub. Date: Jan. 6, 2005

(54) Imaging profile in digital imaging

(75) Inventor: Arto Kiiskinen, San Diego, CA (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/835,254

(22) Filed: Apr. 29, 2004

(30) Foreign Application Priority Data
Apr. 30, 2003 (FI) 20030657

(51) Int. Cl. H04N 5/225

(52) U.S. Cl. 348/207.1

(57) ABSTRACT

The invention relates to a method, a system, a camera device, as well as application software in a digital imaging environment, in which the camera device is used in an imaging session to record image material which comprises still or video image and which image material is further stored as one or more image files. According to the invention, for imaging in said imaging session, the camera device is provided with an imaging profile which comprises one or more parameters relating to said imaging session, wherein data included in said one or more parameters is attached or linked to said one or more image files to identify them as being recorded in said imaging session. The invention facilitates the identification of images recoded in different situations and makes it possible to subject the image files to automatic operations.

### CROSS-REFERENCE TO RELATED APPLICATIONS

This application claims priority under 35 USC §119 to Finnish patent application Ser. No. 20030657 filed on Apr. 30, 2003.

### FIELD OF THE INVENTION

The invention relates to a method in imaging in a digital imaging environment wherein a camera device is used in an imaging session to record image material which comprises one or more still or video images and which image material is further stored as one or more image files. The invention also relates to a system implementing the method, which system comprises at least a camera device for recording image material in an imaging session, which image material comprises one or more still or video images and which image material is further stored in the form of one or more image files. Furthermore, the invention relates to a camera device, which camera device comprises at least means for recording at least one still or video image material in an imaging session, and means for storing said image material further as one or more image files in its memory. The invention also relates to an application software product for implementing the method of the invention.

### BACKGROUND OF THE INVENTION

In general, the present invention relates to the rationalization of photography in a digital imaging environment.

As camera devices recording a still or moving image in digital format, i.e. digital cameras, become more common, it is to be assumed that the quantity of imaging will increase to a significant extent. Imaging will be increased particularly by the introduction of such camera devices, for example camera phones, in which the imaging facility is combined with the availability of wireless communication for the further transmission of images.

This will result in a considerable increase in the quantity of digital images to be stored or processed in another way. Consequently, situations will occur in which the user may have, in his/her camera device or camera phone, tens or even hundreds of images, which have not been named in any particular way.

According to currently prevailing practice, image files are named automatically in the camera device by numbering the files with running numbers only, for example image1.jpg, image2.jpg, etc. Therefore, it is relatively difficult for the user to find a specific image from the image files afterwards, particularly if the image files have been uploaded, for example, into a computer or a server where a large number of images has already been stored in advance. In such photo managing systems in which all the image files are stored in the same directory, there is also the risk that newer files with the same name, i.e., having the same running number, are unintentionally written over previous files. Furthermore, images originating from different imaging sessions cannot be separated from each other solely on the basis of the file names. From the prior art, photo management systems are known which classify the photographs into different directories either by their number, date or format. Also in this case, however, both the photographs and the directories have general names (directory 1, directory 2, photo1, photo2, etc.). The classification of images in the above-mentioned random way into different directories naturally makes it slower and more difficult to find the correct images, which, for example, relate to a specific imaging session or represent a specific object.

From the prior art it is known that the camera device automatically attaches to the image file so-called meta data relating to the image and containing more specific information, for example, about the camera type used for the imaging, the format of the image file, the storage size, the pixel resolution, or the date and time of the moment of imaging. The meta data may further contain information about the camera settings used at the moment of imaging, such as e.g. the shutter time, the flash mode, or the settings of the zoom optics. This meta data follows the image file when it is, for example, uploaded to a server or transmitted with a multimedia message MMS to the device of another user.

However, to identify the images taken of an imaging object in more detail, the user must, according to the prevailing practice, either name the image files manually, one by one, after taking the images, and/or classify the image files manually into several directories named in an appropriate way. This is relatively laborious, particularly when it must be performed when moving and by using a portable device, such as a camera phone or the like.

Also the following methods are known from prior art, in which after the images have been taken, they are to be automatically classified into different directories.

Patent publication JP 11262030 A describes a method in which a key word is recognized of an image taken by a digital camera, which key word is presented in a reference table taken along with the actual object in the image. On the basis of this key word, images recorded on a memory card are further stored automatically in directories corresponding to different key words in a computer. This method is naturally only suitable for pre-arranged imaging sessions, in which imaging is primarily used for professional documentation of images, or the like.

Patent publication JP 2001144921:n describes a method, in which image files are stored in different directories according to the memory means (memory card), which the image files originate from. In the case of a single user, the successful application of this method would require the use of several memory cards in a digital camera, wherein each memory card would be reserved for a different purpose. When images are downloaded from memory cards, the files contained in different cards would thus automatically end up in different directories.

U.S. Pat. No. 6,507,363 presents a method in which image files of images taken with a digital camera are supplemented, as meta data, with information of the individual camera with which the image was taken. Furthermore, the images are automatically recorded in several different directories in the camera. Also in this arrangement, with respect to their image content (object represented by the images), the images taken with the same individual camera cannot be easily distinguished from each other and be classified in more detail, for example in a way corresponding to the imaging session.

### SUMMARY OF THE INVENTION

The main purpose of the present invention is to disclose a new and inventive arrangement, which further facilitates to a significant extent the recording of images as well as their later use. By means of the invention, the images can, for example, be named automatically in a way, which makes it possible to easily identify single images to relate to a specific imaging session and thereby an object of imaging. Furthermore, the invention makes it possible to automatically classify the images into different folders according to the imaging session when the images are transmitted further, for example, to a server. Thanks to the invention, the user does not need to name each single image separately when the image file is stored. By means of the invention, the image files can be supplemented or linked with identifiers which define, for example, the access rights of other users to the image files and which also make it possible to subject the image files to automatic operations.

To attain these purposes, the method according to the invention is a method in a digital imaging environment, in which a camera device is used in an imaging session to record image material which comprises one or more still or video images and which image material is further stored as one or more image files, wherein for imaging in said imaging session, the camera device is provided with an imaging profile which comprises one or more parameters relating to said imaging session, the data included in said one or more parameters being attached or linked to said one or more image files to identify them as being recorded in said imaging session. The system according to the invention is, in turn, primarily a system in a digital imaging environment, which system comprises at least a camera device for recording image material in an imaging session, which image material comprises one or more still or video images and which image material is further stored in the form of one or more image files, wherein the system also comprises means for providing the camera device with an imaging profile for recording in said imaging session, which imaging profile comprises one or more parameters relating to said imaging session, and further comprises means for attaching or linking data included in said one or more parameters to said one or more image files, for identifying them as being recorded in said imaging session. The camera device according to the invention is a digital camera device, which camera device comprises at least means for recording at least one still or video image material in an imaging session, and means for storing said image material further as one or more image files in its memory, wherein the camera device also comprises means for creating an imaging profile in the camera device or for receiving it from the outside of the camera device for imaging in said imaging session, which imaging profile comprises one or more parameters relating to said imaging session, and further comprises means for attaching or linking data included in said one or more parameters to said one or more image files, for identifying them as being recorded in said imaging session. Further, the application software product according to the invention is an application software product for a digital imaging environment, in which imaging environment a camera device is used in an imaging session to record image material which comprises at least one still or video image and which image material is further stored as one or more image files, wherein said application software product has program code stored in a processor readable memory for causing a processor to create for the imaging session an imaging profile which comprises one or more parameters relating to said imaging session, and which imaging profile is provided for imaging in the imaging session, wherein the data included in said one or more parameters is attached or linked to said one or more image files to identify them as being recorded in said imaging session. The other, dependent claims will also present some advantageous embodiments of the invention.

The gist of the present invention can be considered to be the fact that different imaging profiles for different imaging sessions are created in advance in the camera device. When a given imaging profile is selected for use in the camera device, said imaging profile can be used to automatically name the image files of the taken pictures, in a way defined in the imaging profile, and/or the image files can be supplemented or linked with an image identifier. Said image identifier, which may be attached, for example, as meta data to the image file, may include one or more items of data or parameters defined in the imaging profile, such as typically, for example, the target location where the image file is stored or transferred by default when downloaded from the camera device. This target location may be a specific file directory in a specific server or, for example, a telephone number of a multimedia communication device, or an IP address complying with the Internet protocol. The image identifier may also contain information, for example, about the access rights of other users relating to the image file, and other operations, which the image filed is automatically subjected to.

What is new in the invention is to take a photograph (or a video recording) in a digital imaging environment by using an imaging profile according to the imaging session, whereby it will be significantly easier for the user to identify and handle the image files later on. Thanks to the invention, it is also easy to automate the operations, which the image file should be subjected to, if necessary, because parameters suitable for this purpose can be included in the image identifier.

In the arrangement according to the invention, imaging profiles can be created, for example, by means of an application to be run in a personal computer or an application implemented as pages in the Internet. The imaging profiles can be transferred to the camera device by using either a wireless or a cabled connection. It is also possible to create or edit the imaging profiles in the camera device itself. If the camera device is a mobile station equipped with a wireless data transmission connection, such as a camera phone, imaging profiles can be transmitted e.g. as multimedia messages to the mobile station. If necessary, the imaging profiles can also be transmitted from one mobile station to another, for example between two camera phones.

In one embodiment of the invention, in which the camera device is a mobile station, the imaging profile is created either in whole or in part by using other possible profile functions of the mobile station. In modern mobile stations, such profile functions are relatively common and they can be used to select a particular mode for the mobile station, for example with respect to the alarm tones (silent, conference, outdoors, etc.). The settings and data of such a mode can be automatically included in the imaging profile and further as meta data in the image identifiers. Some or all of the imaging profiles stored in the mobile station may also be selected for use in the same way as the other user profile functions, in other words, by means of the same key/switch intended for selecting the profiles.

The most significant advantages to be achieved with the invention relate to the fact that when image files are transmitted in the uplink direction, for example to web applications or the like, the image identifiers according to the invention can be used to simultaneously transmit information about what is to be done with the image files after the transmission. This makes it possible, for example, to publish the images immediately after the transmission e.g. on Internet pages, or they can be distributed in a predetermined way to other users, for example to their e-mail addresses. Consequently, the invention supports fully mobile imaging and makes it possible to automatically process and/or transmit the images further according to the needs in each situation.

### BRIEF DESCRIPTION OF THE DRAWING

The invention and its advantages will be more evident for a person skilled in the art from the appended more detailed description, in which the invention is explained by means of selected examples and with reference to the appended FIG. 1.

FIG. 1 is a block chart illustrating the principle of a system implementing the invention.

### DETAILED DESCRIPTION OF THE INVENTION

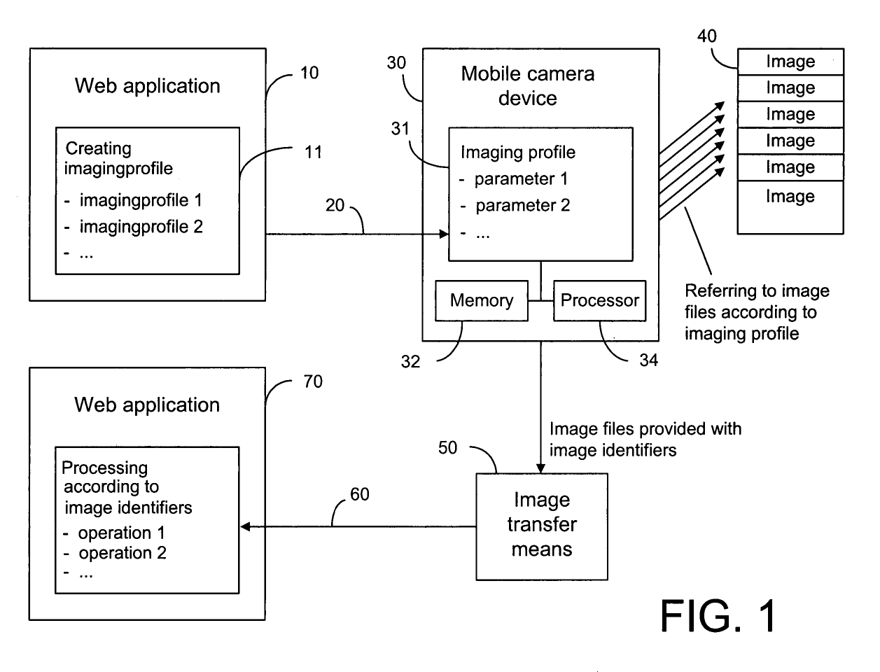

FIG. 1 shows an example of a system according to the invention, implemented in a digital imaging environment. According to this example, a web application 10 implemented as Internet pages is used by a user to draw up one or more imaging profiles 11, of which one or more are further transferred to the memory of a mobile camera device 30, in this case by using a wireless data transmission connection 20. The single imaging profile may contain one or more parameters, which parameters may be, for example, file name, target location, access right data, and various procedural instructions.

When the user starts imaging with the camera device 30 in a specific imaging session, he/she selects an imaging profile 31 suitable for the imaging session from the memory of the camera device. Depending on the properties of the camera device 30, one or more imaging profiles may be stored in its memory. Preferably, the camera device 30 as such also comprises means for editing the imaging profiles or creating totally new imaging profiles solely by using the functions of the camera device 30.

It will be obvious for a person skilled in the art that the production of imaging profiles in the web application 10 or in the camera device 30 may take place by means of application software designed for the purpose.

When the camera device 30 is used for taking digital images 40, said images are recorded as image files in the memory of the camera device 30 by referring to the image files according to the imaging session 31 in use. In this context, referring to the image files means that the image files are named according to a specific parameter, e.g. the file name, of the imaging profile, and/or that an image identifier is attached or linked to the image files. Said image identifier may include one or more parameters defined in the imaging profile. The image identifier may be attached to a single image file, for example, as meta data, or in another way by linking the image identifier and the image file together. The camera device can include application software code stored in memory 32 for execution by processor 34 so as to implement the imaging profile.

When image files are named according to a file name included in the imaging profile (or another parameter included in the imaging profile), the names of the image files can be generated, for example, as a combination of said file name and a running number. In this way, the same imaging profile can be used to take several images, which are distinguished from each other by the running numbers.

The imaging profile/image identifier may comprise one or more parameters containing procedural instructions, according to which the image files can be subjected to automatic operations already in the camera device 30 and/or later on when the image files are transferred, for example, to a server or a personal computer.

One of the parameters included in the imaging profile/image identifier may be the target location where the image files are transferred/stored by default when they are uploaded from the camera device 30 in the uplink direction. This target location may be a specific file directory in a specific server or, for example, the telephone number of a multimedia communication device, or an IP address complying with the Internet protocol, or an e-mail address. The image files can be transmitted, for example, from one camera phone to another camera phone.

The imaging profile/image identifier may also contain information about, for example, the access rights of other users to the image file in a situation in which the image files have been transferred to a target location where they are accessible by other users.

As shown in FIG. 1, the data files named in the way defined in the imaging profile and/or containing an image identifier are transferred by transfer means 50 from the mobile camera device 30 further in the uplink direction to a web application 70. In the case of a camera phone, said transfer means 50 may, for example, set up a wireless data transmission connection 60. However, the communication 60 may also be implemented in any other way known as such, for example as a cabled connection based on parallel or serial data transmission.

The image identifiers may be attached to the image files in the form of meta data or in any other way known as such, to link the data included in the imaging profile with the image files when the images are taken. In the further transmission of the image files from the imaging device 30, the data included in the imaging profile may be attached to the image file, for example in a so-called image upload package.

Now, thanks to the invention, it is possible in the web application 70 to subject the image files to one or more automatic operations according to the parameters included in the image identifiers. In addition to those mentioned above, the operations may include certain operations relating to digital image processing. For the publication of the images on Internet pages, for example, the images can be re-sampled to a smaller pixel size, wherein they require less storage capacity and are downloadable faster for viewing. It is also possible to automatically create smaller icons for previewing the images. The procedural instructions of the image identifiers may also relate, for example, to changing the luminosity, the contrast, or the number of grey or colour tone levels.

It is also possible that when the imaging profile is defined in the web application 10, the actual parameters included in the imaging profile (e.g. target location of image files, access right data and procedural instructions relating to image files) are not transferred at all to the camera device 30 but the images taken by using the imaging profile in the camera device are only named or identified in another way as taken by using said imaging profile. First when the image files are transferred from the camera device to the web application 70, said parameters of the imaging profile are retrieved and attached to the image files in the form of meta data or linked with the image files in another way. In this case, the data included in the imaging profile are utilized substantially first when the image files are in a server or the like.

In the following, some example situations and applications will be presented, of which the advantages to be achieved by the invention in practice will be obvious for a person skilled in the art.

### Imaging Profile “Party”

The user defines, either by means of a web application or directly by using a camera phone as the camera device, an imaging profile “Party” to be ready in the memory of the camera phone. In the imaging profile, he/she determines the address of a given Internet directory as the target location for the image files. When attending a party, he/she activates said imaging profile in his/her camera phone before starting to shoot. When transferring the image files from the camera phone wirelessly further to an Internet server, the image files will automatically end up in the correct target location (e.g. in a directory . . . Party under the file names Party1.jpg, Party2.jpg etc.), where they are immediately viewable and downloadable by friends of the user. When so willing, the user has, already when setting up the imaging profile, been able to define more closely the parties to have access to said directory as well as the operations to which said parties can subject the image files in the directory.

### Imaging Profile “Sales Object A”

A real estate agent is going to check a house A which he/she has been commissioned to sell. Before leaving, he/she creates an imaging profile in his/her camera device equipped with a wireless data transmission connection, to define a target location for image files as well as a reminder that he/she should remember to take pictures of the living room, kitchen, bedrooms, bathroom as well as the front and back yards of the sales object. He/She also attaches all the other data relating to the sales object as different parameters to the imaging profile.

When arrived at the house, he/she takes all the pictures of which he/she is reminded by the imaging profile when it is selected for use in the camera device. Consequently, in this case, the functions of the camera device include a function in which the user of a given imaging profile acknowledges the pictures included as reminders in the profile when they are taken one by one. Moreover, to be on the safe side, the user here takes some extra pictures in addition to those set as reminders.

When transferring the image files wirelessly forward to the target location in an Internet server, the pictures of the sales object A as well as all the other data of the sales object, stored in the imaging profile, are immediately available to his/her clients. The image files are stored, for example, in a directory . . . SalesobjectA under the file names livingroom.jpg, kitchen.jpg, etc.

On the same occasion, the real estate agent can also visit other sales objects, and by using at each object the imaging profile especially set up for it, the image files with correct data end up in their correct target locations, even though they were all uploaded to the server at the same time at the end of the visiting tour.

In this way, the invention makes it significantly easier and more versatile both to take the pictures and particularly to use and utilize the images later on. By means of the invention, images taken in a specific situation can be supplemented with information relating to the imaging situation or the later handling of the image files, as meta data or linked in another way. This makes it possible e.g. to classify the image files automatically and to subject them to automatic operations later on. By means of the invention, the images are also classified automatically according to their image content (imaging session).

By means of the invention, the user can, particularly when imaging with a mobile device, create an arrangement whereby images taken in different sessions (of different objects) are automatically classified in their correct predetermined target locations, and the access rights of the image files are determined in a predetermined way. Some of the images can, for example, be immediately set on view for all Internet users in the web; to some images, access is allowed for specific parties only; and some images can be maintained completely private, if so desired.

By means of the invention, it is possible to implement, for example, an arrangement by which images taken with a specific imaging profile are automatically transmitted further from the camera device, such as a camera phone, to one or more e-mail addresses or, for example, to another camera phone.

By the arrangement based on the imaging profile according to the invention, a larger number of applications can be found which will be obvious for a person skilled in the art on the basis of the above description and examples.

For example, the camera device according to the invention may be a multimedia phone with imaging facility, a camera phone, or a so-called personal digital assistant (PDA device), which includes mobile station facilities in addition to the imaging facility.

It should be noted, however, that the invention is not limited solely to camera devices equipped with a wireless data transmission connection, but it can also be applied, for example, in digital cameras equipped with a universal serial bus (USB) or a corresponding cabled data transmission bus. Furthermore, the invention can also be applied in camera devices in which the images are recorded and transferred by using memory cards or the like. In this case, the imaging profile is preferably created in the camera device itself, or the image identifiers complying with the imaging profile are stored together with the image files in the memory card.

Furthermore, the invention is not limited solely to camera devices taking still images but, obviously, it can also be applied to camera devices recording a moving, i.e. video image in digital format. Moreover, image material equipped with image identifiers according to the invention can be included, for example, as a part of multimedia messages in such a way that the image identifiers are attached to the multimedia message in whole or in part. The image format to be used in connection with the invention can be freely selected according to the application in each case, and it is thus not restricted in any way as to the colour system, pixel quantity, or the file format to be used for recording the image material.

1. A method in a digital imaging environment, in which a camera device is used in an imaging session to record image material which comprises one or more still or video images and which image material is further stored as one or more image files, wherein for imaging in said imaging session, the camera device is provided with an imaging profile which comprises one or more parameters relating to said imaging session, the data included in said one or more parameters being attached or linked to said one or more image files to identify them as being recorded in said imaging session.

2. The method according to claim 1, wherein said one or more image files are named by means of data included in one or more parameters of the imaging profile.

3. The method according to claim 1, wherein said one or more image files are supplemented with an image identifier in the form of meta data or in another way, the image identifier containing data included in one or more parameters of the imaging profile.

4. The method according to claim 1, wherein said one or more image files are transferred further from the camera device and the data included in the imaging profile/image identifier is utilized to determine operations which the image files are to be automatically subjected to.

5. The method according to claim 4, wherein said one or more image files are stored in or transmitted to a target location indicated by the imaging profile/image identifier.

6. A system in a digital imaging environment, which system comprises at least a camera device for recording image material in an imaging session, which image material comprises one or more still or video images and which image material is further stored in the form of one or more image files, wherein the system also comprises means for providing the camera device with an imaging profile for recording in said imaging session, which imaging profile comprises one or more parameters relating to said imaging session, and further comprises means for attaching or linking data included in said one or more parameters to said one or more image files, for identifying them as being recorded in said imaging session.

7. The system according to claim 6, wherein the means for providing the camera device with an imaging profile comprises means outside the camera device for creating the imaging profile and transferring it to the camera device.

8. The system according to claim 6, wherein the means for providing the camera device with an imaging profile are placed in the camera device itself.

9. The system according to claim 6, wherein said system comprises means for naming said one or more image files by means of data included in one or more parameters of the imaging profile.

10. The system according to claim 6, wherein the system comprises means for attaching an image identifier to the image file in the form of meta data or in another way, the image identifier containing data included in one or more parameters of the imaging profile.

11. The system according to claim 6, wherein the system also comprises means for downloading said one or more image files from the camera device and for utilizing data included in the imaging profile/image identifier to define operations which the image files are automatically subjected to.

12. The system according to claim 11, wherein the system comprises means for storing said one or more image files or transferring them to the target location indicated by the imaging profile/image identifier.

13. The system according to claim 6, wherein the camera device is a mobile device equipped with a wireless data transmission connection, preferably a camera phone.

14. The system according to claim 6, wherein the camera device is arranged in a data transmission connection with an external computer, a server, an Internet web application, a mobile device, or another camera device, for the transfer or processing of the imaging profile or the image files.

15. A digital camera device, which camera device comprises at least means for recording at least one still or video image material in an imaging session, and means for storing said image material further as one or more image files in its memory, wherein the camera device also comprises means for creating an imaging profile in the camera device or for receiving it from the outside of the camera device for imaging in said imaging session, which imaging profile comprises one or more parameters relating to said imaging session, and further comprises means for attaching or linking data included in said one or more parameters to said one or more image files, for identifying them as being recorded in said imaging session.

16. The camera device according to claim 15, wherein the camera device comprises means for naming said one or more image files by means of data included in one or more parameters of the imaging profile.

17. The camera device according to claim 15, wherein the camera device comprises means for attaching an image identifier as meta data or in another way to the image file, the image identifier containing data included in one or more parameters of the imaging profile.

18. The camera device according to claim 15, wherein the camera device also comprises transfer means for transferring said imaging profile or said one or more image files from the camera device further to an external computer, a server, an Internet web application, a mobile device, or another camera device.

19. The camera device according to claim 18, wherein said transfer means are based on wireless communication.

20. The camera device according to claim 19, wherein the camera device is a camera phone.

21. An application software product for a digital imaging environment, in which imaging environment a camera device is used in an imaging session to record image material which comprises at least one still or video image and which image material is further stored as one or more image files, wherein said application software product has program code stored in a processor readable memory for causing a processor to create for the imaging session an imaging profile which comprises one or more parameters relating to said imaging session, and which imaging profile is provided for imaging in the imaging session, wherein the data included in said one or more parameters is attached or linked to said one or more image files to identify them as being recorded in said imaging session.

22. The application software product according to claim 21, wherein it is arranged to be run in the camera device.

23. The application software product according to claim 21, wherein it is arranged to be run outside the camera device.
